(19) United States
(12) Patent Application Publication
(10) Pub. No.: US 2025/0058300 A1
(43) Pub. Date: Feb. 20, 2025

(54) METHODS AND SYSTEMS FOR OPERATING A SULFUR RECOVERY UNIT

(71) Applicant: SAUDI ARABIAN OIL COMPANY, Dhahran (SA)

(72) Inventors: Tarek D. ABOGHONIEM, Udhailiyah (SA); Faisal A. ALAIFAN, Udhailiyah (SA); Jalal A. BOJBARAH, Udhailiyah (SA); Zuhair S. ALABDRABULRIDHA, Udhailiyah (SA)

(73) Assignee: SAUDI ARABIAN OIL COMPANY, Dhahran (SA)

(21) Appl. No.: 18/451,891

(22) Filed: Aug. 18, 2023

(51) Int. Cl. B01J 20/34; B01D 53/02; B01J 20/20

(52) U.S. Cl. CPC B01J 20/3416; B01D 53/02; B01J 20/20; B01D 2257/7027; B01J 2220/56

(57) ABSTRACT

Improved processes and systems for sweeping an activated carbon bed after steam regeneration to decrease or prevent the occurrence of flameouts or unit trips in a reaction furnace of a low-pressure sulfur recovery unit. The improved sweeping process includes conveying a sweeping gas to the reaction furnace at a sweeping flow rate that is less than an operational flow rate of the activated carbon bed. The improved system includes a bypass line that bypasses at least a portion of the main outlet line of the activated carbon bed to result in a reduced sweeping flow rate. The improved sweeping process may include starting the sweeping process after the temperature of the active carbon beds drops below a threshold level.

### FIELD OF THE DISCLOSURE

The present disclosure relates generally to systems and processes for operating a

sulfur recovery unit and, more particularly, to systems of reducing reaction furnace down time after steam regeneration of an activated carbon bed in a low pressure sulfur recovery unit.

### BACKGROUND OF THE DISCLOSURE

In the oil and gas industry, hydrocarbon gases that include acidic gases such as hydrogen sulfide, carbon dioxide, and other similar acidic gases are called acid gases. Low-pressure sulfur recovery units (“SRU”) remove sulfur compounds from acid gases. Some SRUs use a Claus catalyst containing catalytic converter to convert sulfur dioxide in an acid gas to elemental sulfur. Acid gases may also contain aromatic compounds, such as benzene, toluene, and xylene, which can deposit coke on active sites within the pore structure of the Claus catalyst, which can crack the catalyst or result in its deactivation. Deactivation of the Claus catalyst can result in poor sulfur recovery by the SRU and violations of ambient air norms. To protect the Claus catalyst, the aromatic compounds need to be removed from the acid gases.

To remove aromatic compounds from acid gases, the SRU may include an activated carbon bed to adsorb the aromatic compounds prior to exposure to the Claus catalyst. After the aromatic compounds are removed from the acid gas by adsorption in the activated carbon bed, the acid gases are delivered to an acid gas pre-heater and then to a reaction furnace, which combusts H₂S in the acid gas to produce SO₂. SO₂ is reacted by a Claus catalyst in a catalytic converter into elemental sulfur. The elemental sulfur leaving the catalytic converter is cooled and condensed into a liquid, which is collected and stored.

During the removal of aromatic compounds, the activated carbon bed becomes saturated with the aromatic compounds and requires regeneration to restore its absorptive capacity. Regeneration of the activated carbon bed may be accomplished by passing steam through the bed. It has been observed that after an activated carbon bed undergoes steam regeneration and the activated carbon bed is prepared to be brought back online in a sweeping process, flame out events and unit trips may occur in the reaction furnace causing significant and expensive down time of the SRU. Methods of regenerating the activated carbon bed and sweeping it before bringing it back online are needed that reduce or eliminate the occurrence reaction furnace flameouts, unit trips, and SRU down time.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method of restoring the adsorptive capacity of an activated carbon bed in a low-pressure sulfur recovery unit (“SRU”), the method including regenerating with steam an activated carbon bed of an SRU that has been saturated with an aromatic compound, feeding a sweeping gas through the regenerated activated carbon bed, and conveying the sweeping gas from the activated carbon bed to a reaction furnace at a sweeping flow rate for a duration sufficient to prevent flameout in the reaction furnace.

In a further embodiment, an activated carbon bed system in a SRU configured to remove aromatic compounds from an acid gas when operated in an adsorption mode and further configured to be regenerated with steam when operated in a regeneration mode and further configured to conduct a sweeping process between the regeneration mode and adsorption mode to prevent flameout in a reaction furnace. The activated carbon bed system may include an activated carbon bed including a drum containing activated carbon that may include an acid gas inlet in a lower portion of the drum, a main outlet in an upper portion of the drum, a steam inlet in an upper portion of the drum, and a steam outlet in a lower portion of the drum. The system may further include a main outlet line in fluid communication with the main outlet of the activated carbon bed, the main outlet line having a first diameter and a main outlet valve in the main outlet line, the main outlet valve configured to prevent the flow of an acid gas through the main outlet line when closed. The system may further include a bypass line configured to allow a sweeping gas to bypass at least a portion of the main outlet line, the bypass line having a second diameter that is less than the first diameter of the main outlet line, and a bypass line valve in the bypass line, the bypass line valve configure to stop the flow of an acid gas through the bypass line when closed.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of an example sulfur recovery unit in accordance with embodiments of the disclosure.

### DETAILED DESCRIPTION

Embodiments of the present disclosure will now be described in detail with reference to the accompanying Figure. Like elements in the figure may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figure may vary without departing from the scope of the present disclosure.

Embodiments in accordance with the present disclosure generally relate to systems and processes for removing unwanted aromatic compounds from an acid gas and, more particularly, to systems of reducing the occurrence of reaction furnace downtime after steam regeneration of an activated carbon bed in a sulfur recovery unit (SRU) used to remove sulfur from an acid gas. An acid gas in the oil and gas industry is a hydrocarbon gas that may include acidic gases such as hydrogen sulfide, carbon dioxide, and other similar acidic gases. In some environments, sulfur gases, such as hydrogen sulfide, must be removed from the acid gas. To remove sulfur gases, an acid gas may be processed by an SRU. An SRU converts hydrogen sulfide gas into sulfur dioxide in a reaction furnace, which is then converted to elemental sulfur in a catalytic converter containing a Claus catalyst. Aromatic compounds in an acid gas, such as benzene, toluene, and xylene, collectively referred to herein as “BTX”, may deposit coke on active sites within the pore structure of the Claus catalyst, which can crack the catalyst or result in its deactivation, which can, in turn, result in poor sulfur recovery by the SRU, release of sulfur containing gases into the environment, and violations of ambient air norms.

Activated carbon beds are used to remove unwanted aromatic compounds from an acid gas to reduce or prevent the negative impact of these compounds on the Claus catalyst in a catalytic converter. The activated carbon in the beds remove aromatic compounds by adsorbing the compounds from the acid gas as the acid gas is passed through the bed, thereby reducing the aromatic compound load in the acid gas. The activated carbon bed has a limited capacity for adsorbing aromatic compounds from an acid gas. A saturated carbon bed, such as a carbon bed that has reached or is approaching reaching its maximum adsorptive capacity, may be regenerated to restore its absorptive capacity.

According to embodiments of this disclosure, the activated carbon bed is regenerated with steam that is flowed through the bed in a direction opposite to the normal flow of an acid gas. Steam flowing through the activated carbon bed picks up the aromatic compounds from the activated carbon bed and carries the compounds away from the bed, thereby making the bed ready for the next cycle of adsorption. During regeneration, the activated carbon bed is unavailable for use in removing aromatic compounds from an acid gas. Accordingly, in the typical arrangement, several activated carbon beds operate in parallel to remove aromatic compounds from an acid gas for the SRU. Each of the activated carbon beds may cycle between an adsorption mode, also referred to as “operations mode,” during which acid gas admission to the activated carbon bed results in removal of aromatic compounds from the acid gas, and a regeneration mode, during which aromatic compounds are removed from the activated carbon bed thereby making it ready for the next cycle of adsorption. At a given moment, an activated carbon bed may be in regeneration mode while other beds are in adsorption mode.

After the activated carbon bed has undergone regeneration, and before the start of the adsorption mode, the activated carbon bed undergoes a sweeping process to prepare it for operations. During the sweeping process, a sweeping gas is flowed through the activated carbon bed to cool the bed and remove residual moisture that remains from the steam regeneration mode. Previously used sweeping processes utilized the main outlet line and valve, which have a large diameter to direct the sweeping gas to the reaction furnace. However, it was observed that this process resulted in reaction furnace flameouts and unit trips likely due to the high flow rate of moisture laden sweeping gas reaching the furnace during the initial stages of the sweeping process.

As described in greater detail herein, the improved sweeping process in accordance with the principles of the present disclosure includes a step of having reduced volume flow of sweeping gas relative to the flow of sweeping gas when using the main outlet line and valve in the prior art process from the activated carbon bed to the reaction furnace. The improved sweeping process reduces, and in some embodiments, prevents flameouts and unit trips in the reaction furnace.

Details of the improved sweeping process are set forth below.

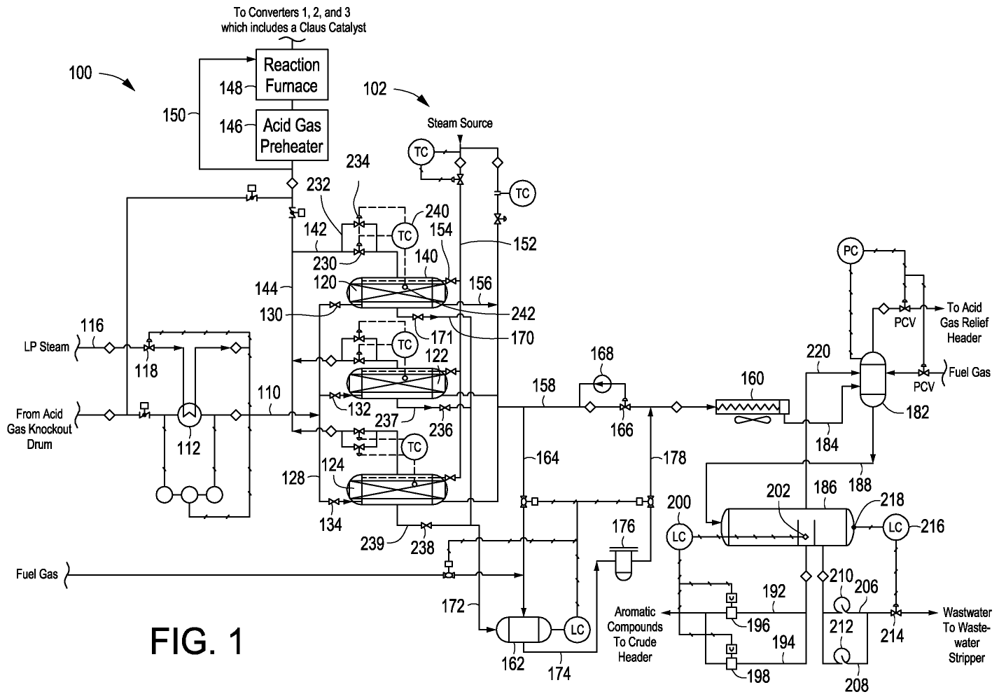

The FIGURE or FIG. 1 is a schematic illustration of an example SRU 100 and associated components, which form an activated carbon bed system 102 for removing aromatic compounds from an acid gas. A wet acid gas, such as a wet acid gas from a knockout drum of a hydrocarbon gas processing facility, is fed into the activated carbon bed system 102 via an acid gas conduit 110. Prior to entering the activated carbon bed system 102, the wet acid gas is heated in an acid gas heater 112 to reduce the humidity in the acid gas, thereby producing a dry acid gas. Drying the acid gas optimizes it for the adsorption of the aromatic compounds by the activated carbon bed system 102. In embodiments, the acid gas heater 112 is heated with steam from a steam conduit 116. In embodiments, the flow of steam through the steam conduit 116 may be controlled by a temperature control valve 118 that may receive temperature data from temperature sensors associated with the acid gas conduit 110 upstream and downstream of the acid gas heater 112.

After passing through the acid gas heater 112, the dry acid gas is conveyed to an activated carbon bed 120, 122, 124 in the activated carbon bed system 102 by conduit 128. The embodiment illustrated in FIG. 1 includes three activated carbon beds 120, 122, 124. In embodiments, conduit 128 may include valves 130, 132, 134 controlling the flow of acid gas into each of the activated carbon beds 120, 122, 124, respectively, and thereby allowing each activated carbon bed 120, 122, 124 to be isolated, such as for cycling between adsorption mode and regeneration modes or maintenance. In embodiments, the operation of valves 130, 132, 134 made be controlled by a controller (not shown). When each of the activated carbon beds 120, 122, 124 are operating in the adsorption mode, the respective valves 130, 132, 134 are open allowing acid gas to flow into the activated carbon beds 120, 122, 124. When each of the activated carbon beds 120, 122, 124 are operating in the regeneration mode, the respective valves 130, 132, 134 are closed thereby isolating the activated carbon beds with the closed valve 130, 132, 134.

For clarity, the following description will focus on one activated carbon bed 120, but the description applies to all activated carbon beds 120, 122, 124 that may be included in an activated carbon bed system 102 of an SRU 100.

Activated carbon beds are known and typically include a drum 140, activated carbon, and associated support structures such as trays and internal conduits (not shown).

Typically, the acid gas enters the drum 140 of the activate carbon bed 120 from a lower portion of the drum 140 and flows up through the activated carbon where aromatic compounds are adsorbed. After passing through the activated carbon, the acid gas exits the top of the drum 140 via main outlet line 142. Main outlet line 142 ties into conduit 144, which conveys the acid gas to an acid gas preheater 146 where it is heated to reaction temperature prior to being fed to the reaction furnace 148. During normal operating conditions of an SRU with three activated carbon beds 120, 122, 124, two of the activated carbon beds 120, 122, or 124 will be in adsorption mode while one activated carbon bed (the other of 120, 122, or 124) will be in regeneration mode. After the activated carbon in an activated carbon bed 120, 122, 124 becomes saturated, the activated carbon bed 120, 122, 124 is transitioned to (enters) the regeneration mode. One of ordinary skill will understand that when used in the context of an activated carbon bed 120, 122, 124, the term “saturated” may include activated carbon beds with activated carbon that is saturated to maximum capacity as well as activated carbon beds with activated carbon that is partially saturated.

Processes for steam regeneration of activated carbon beds are known. Generally, during the regeneration mode of a saturated activated carbon bed 120, the activated carbon bed 120 is isolated, such as by stopping the flow of acid gas to the activated carbon bed 120 by closing valve 130 in acid gas conduit 110. After the activated carbon bed 120 is isolated, it is prepared for regeneration and drained. Then, steam from the steam line 152 is introduced to the top of the drum 140 of the activated carbon bed 120. Steam conduit 152 may include one or more valves 154 that control the flow of steam to each activated carbon bed 120, 122, 124. The steam flows through the activated carbon in the drum 140 countercurrent to the normal flow of acid gas to desorb aromatic compounds from the activated carbon.

After passing through the activated carbon, a portion of the steam may condense to form a condensate that collects in the bottom of the drum 140 and the remainder of the steam will remain in gaseous form. The gaseous portion of the steam exits from a lower portion of the drum 140 via steam conduit 156. The steam conduits 156 from each activated carbon bed 120, 122, 124 may merge into a single steam conduit 158 that carries the steam to a condenser 160. Some steam may be directed to a condensate collection drum 162 via line 164. In embodiments, the steam conduit 158 may include a flow control valve 166 with associated controller 168.

The condensate portion of the steam exits from bottom of the drum 140 via condensate drain line 170. The condensate drain lines 170 from each activated carbon bed 120, 122, 124 may merge into a single condensate drain line 178 that carries the steam to the condensate collection drum 162. In embodiments, the condensate exiting the condensate collection drum 162 may flow through a condensate conduit 174 to a filter 176 to remove fine particles from the condensate before being conveyed to the condenser 160 via conduit 178. The condenser 160 condenses uncondensed steam to form a condensate, which flows to a pressure control drum 182 via conduit 184.

The condensate then flows from the pressure control drum 182 to a three-phase separator 186 via conduit 188. In the three-phase separator 186, the condensate is separated into an oil fraction, wastewater fraction, and non-condensable gas fraction. The oil fraction, which includes the aromatic compounds, may then be pumped from the separator 186 to the crude injection line via conduits 192 and 194, which may include pumps 196 and 198. In embodiments, the operation of the pumps 196, 198 may be controlled by a level controller 200, which receives data from a level sensor 202 in the oil fraction well of the three-phase separator 186. In embodiments, the waste water may be pumped to a wastewater stripper to remove dissolved hydrocarbons via conduits 206 and 208, which may include pumps 210 and 212. The waste water conduit 206 may include a level control valve 214 controlled by a level controller 216 receiving data from a level sensor 218 in the water fraction well of the three-phase separator 186. The non-compressible gases may be conveyed to the pressure control drum 182 via conduit 220.

An activated carbon bed 120, 122, or 124 may undergo regeneration for a duration sufficient to restore a desired level of the adsorptive capacity of the activated carbon in the drum 140 of the activated carbon bed. In an embodiment, the desired level of adsorptive capacity is at least 80 percent of the adsorptive capacity of the activated carbon. In another embodiment, the desired level of adsorptive capacity is at least 90 percent of the adsorptive capacity of the activated carbon. In another embodiment, the desired level of adsorptive capacity is at least 95 percent of the adsorptive capacity of the activated carbon.

After an activated carbon bed 120, 122, or 124 has completed the regeneration process, it is depressurized and may enter a standby mode before it begins preparation for reentry into the adsorption mode. To prepare the activated carbon bed 120, 122, 124 for reentry into the adsorption mode, it undergoes a sweeping process. In embodiments, the sweeping gas is an acid gas.

During the sweeping process for activated drum 120, activated drums 122 and 124 may be undergoing normal operations. In embodiments, bypass valve 234 in conduit 232 and valve 171 in conduit 170 for activated carbon drum 120 are opened. Additionally, one or both of valve 236 in conduit 237, which exits activated carbon drum 122, and valve 238 in conduit 239, which exits activated carbon drum 124, may be opened. Opening these valves 236 and 238 from activated carbon drums 122 and 124, respectively, during operations mode of activated carbon drums 122 and 124, while simultaneously opening valves 171 and bypass valve 234 for activated carbon drum 120 during its sweeping mode, allows acid gas from activated carbon drums 122 and 124 to sweep through activated carbon drum 120.

In the prior art sweeping process, as the acid gas flows through the activated carbon bed, a main outlet valve 230 in main outlet line 142 is opened thereby allowing acid gas scrubbed of aromatic compounds to flow to the acid gas preheater 146 and the reaction furnace 148. The flow of acid gas to the reaction furnace may be split as needed to result in efficient operation. For example, in embodiments feeding reaction furnace 148 with 33% of acid gas flow directly from the activated carbon is needed for reaction furnace combustion equations. The configuration may be referred to “split-fow” and it is used in SRU low pressure units having a low amount of H₂S. which cannot be all directed to reaction furnace 148. Instead, about 33% of flow is directed to reaction furnace 148 after passing through the acid gas preheater 146 and the balance, i.e. about 66%, flows to the back of the reaction furnace 148 via conduit 150. The H₂S in the acid gas may then be reacted and converted to molten sulfur in one or more downstream catalysts, which includes a Claus catalyst. Embodiments may include three catalysts, which may also be referred to as converter-1, converter-2 and converter-3. Each converter has a specific catalyst type that ensures the reaction is taking place under optimum operating conditions that may include the appropriate pressure and H₂S concentration. In embodiments, sulfur recovery occurs at the outlet to converter-3.

Main outlet valve 230 and main outlet line 142 have a large diameter, such as about 30 inches. In the prior art processes, it was observed that flame outs in the reaction furnace 148 would occur shortly after opening main outlet valve 230 after an activated carbon bed had undergone steam regeneration. The flameouts were found to be caused by moisture carryover from the activated carbon bed after regeneration with steam. To address this problem, and in accordance with embodiments of the present invention, an improved sweeping process was developed to reduce the flow of sweeping gas containing carryover moisture to the reaction furnace during the initial stage of the sweeping process. The sweeping gas flow rate in the improved process is reduced relative to the flow rate of acid gas through the main outlet line 142 and main outlet valve 230 during normal operation, which may be referred to herein as the operational flow rate. In embodiments of the present disclosure, the sweeping flow rate may be a reduced by at least 60% relative to the operational flow rate, i.e., the flow rate of acid gas through the main outlet 142 and main outlet valve 230 during normal operation in the adsorption mode. In other embodiments, the sweeping flow rate may be a reduced by at least 70% relative to the operational flow rate of acid gas. In other embodiments, the sweeping flow rate may be a reduced in a range between about 60% and about 80% relative to the operational flow rate of acid gas. In other embodiments, the sweeping flow rate may be a reduced in a range between about 70% and about 75% relative to the operational flow rate of acid gas. In other embodiments, the sweeping flow rate may be a reduced by about 73%.

In an embodiment of the improved sweeping process, a smaller diameter bypass line 232 with bypass valve 234 was added to the activated carbon bed system 102 to result in the reduced sweeping flow rate to reaction furnace 148 relative to the operational flow rate of the acid gas during normal operation in the adsorption mode. In embodiments, the bypass line 234 bypasses at least a portion of the main outlet line 142. In an embodiment, the diameter of the bypass line 232 may be about 26% the diameter of main outlet line 142. In another embodiment, the diameter of the bypass line 232 may be about 1/4th the diameter of main outlet line 142. In another embodiment, the diameter of the bypass line 232 may be in a range between about 1/3^{rd} the diameter of main outlet line 142 and about 1/4^{th} the diameter of main outlet line 142. In another embodiment, the diameter of the bypass line 232 may be in a range between about 6 inches and about 12 inches and the diameter of main outlet line 142 may be in a range between about 26 inches and about 34 inches. In another embodiment, the diameter of the bypass line 232 may be in a range between about 6 inches and about 10 inches and the diameter of main outlet line 142 may be in a range between about 28 inches and about 32 inches. In another embodiment, the diameter of the bypass line 232 may be about 8 inches and the diameter of main outlet line 142 may be about 30 inches.

In the embodiment illustrated in the FIGURE, the bypass line 232 is added to the main outlet line 142 and spans either side of the main outlet valve 230, however, one will appreciate that an end of the bypass line 232 may be directly coupled to the drum 140 of the activated carbon bed 120, and the other end of the bypass line 232 may be coupled to the main outlet line 142 or conduit 144. In embodiments, the reduction in sweeping flow rate may also be accomplished with a valve, such as main outlet valve 230, in the main outlet line 142 that is configured to partially open to result in the desired reduction in the flow rate.

During the improved sweeping phase, in accordance with embodiments of the disclosure, prior to reentry into the adsorption mode, main outlet valve 230 remains closed while bypass valve 234 is opened, resulting in a reduced sweeping flow rate and carryover moisture through the smaller diameter conduit 232, relative to the operational flow rate of acid gas, such as when the activated carbon bed is in the adsorption mode. The reduced sweeping flow rate is maintained, e.g., bypass valve 234 is open while main outlet valve 230 remains closed, for a duration sufficient to remove sufficient moisture carryover to prevent or reduce the occurrence of flameouts or unit trips in the reaction furnace 148. In an embodiment, the duration is sufficient to remove at least about 75% of the moisture carryover from the activated carbon bed 120 at the sweeping flow rate. In another embodiment, the duration is sufficient to remove at least about 85% of the moisture carryover from the activated carbon bed 120 at the sweeping flow rate. In another embodiment, the duration is sufficient to remove at least about 95% of the moisture carryover from the activated carbon bed 120 at the sweeping flow rate. In an embodiment, the duration may be less than about 60 minutes. In another embodiment, the duration may be less than about 45 minutes. In another embodiment, the duration may be greater than about 15 minutes. In another embodiment, the duration may be between about 15 minutes and about 60 minutes. In another embodiment, the duration is about 30 minutes.

In another embodiment of an improved process in accordance with the disclosure, the sweeping phase starts, e.g., bypass valve 234 opens, after the activated carbon reaches a threshold temperature indicating that the moisture level from steam in the activated carbon bed 120 is at a sufficiently low level to prevent or reduce the occurrence of flameouts or unit trips in the reaction furnace during the sweeping phase. In embodiments, the sweeping phase will not start until a temperature indicator 240 indicates that the temperature of the activated carbon bed 120 is below a threshold temperature. In an embodiment, the threshold temperature may be about 250° F. or less. In another embodiment, the threshold temperature may be about 245° F. or less. In another embodiment, the threshold temperature may be about 240° F. or less. In another embodiment, the threshold temperature may be about 230° F. or less. In another embodiment, the threshold temperature may be less than about 220° F. In another embodiment, the threshold temperature is in a range between about 220° F. and 250° F. In another embodiment, the threshold temperature is in a range between about 235° F. and 245° F. In another embodiment, the threshold temperature may be about 240° F. In embodiments, the temperature indicator 240 may be connected logically and sequentially to a control system that controls the operation of one or both valves 230 and 234 to thereby control the start of the sweeping phase.

After completion of the improved sweeping process, the activated carbon bed 120 is ready for reentry into the adsorption mode and normal operation. When operating in adsorption mode, valve 130 is open, thereby allowing admission of acid gas into the drum 140 of the activated carbon bed 120, and main outlet valve 230 is open, thereby allowing scrubbed acid gas to flow to the reaction furnace 148 at an operational flow rate. In embodiments, valve 232 in the bypass line 232 may be in a closed stated during operation of the activated carbon bed in the adsorption mode.

The terminology used herein is for the purpose of describing particular embodiments only and is not intended to be limiting of the invention. As used herein, for example, the singular forms “a.” “an,” and “the” are intended to include the plural forms as well, unless the context clearly indicates otherwise. It will be further understood that the terms “contains”, “containing”, “includes”, “including.” “comprises”, and/or “comprising.” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method of sweeping an activated carbon bed in a low-pressure sulfur recovery unit (“SRU”), the method comprising:
regenerating with steam an activated carbon bed of an SRU that has been saturated with an aromatic compound;
feeding a sweeping gas through the regenerated activated carbon bed; and
conveying the sweeping gas from the activated carbon bed to a reaction furnace at a sweeping flow rate for a duration sufficient to prevent flameout in the reaction furnace.

2. The method of claim 1, wherein the sweeping gas is an acid gas.

3. The method of claim 1, wherein the sweeping flow rate is reduced relative to an operational flow rate of acid gas from the activated carbon bed to the reaction furnace during normal operation of the activated carbon bed in an adsorption mode to remove aromatic compounds from the acid gas and the duration is a duration sufficient to remove sufficient moisture carryover to prevent flameout in the reaction furnace.

4. The method of claim 2, wherein the sweeping flow rate is reduced by range between about 70% and about 75% relative to the operational flow rate.

5. The method of claim 2, wherein the sweeping flow rate is reduced by a range between about 60% and about 80% relative to the operational flow rate.

6. The method of claim 1, wherein the duration sufficient to prevent flameout in the reaction furnace is less than about 60 minutes.

7. The method of claim 1, wherein the duration sufficient to prevent flameout in the reaction furnace is about 30 minutes.

8. The method of claim 1, further comprising measuring a temperature in the activated carbon bed prior to starting the sweeping process, and starting the sweeping process when the temperature of the activated carbon bed falls below a threshold temperature.

9. The method of claim 8, wherein the threshold temperature is about 250° F. or less.

10. An activated carbon system bed system in a low-pressure sulfur recovery unit (“SRU”) configured to remove aromatic compounds from an acid gas when operated in an adsorption mode and further configured to be regenerated with steam when operated in a regeneration mode and further configured to conduct a sweeping process between the regeneration mode and adsorption mode to prevent flameout in a reaction furnace, the activated carbon bed system comprising:
an activated carbon bed including a drum containing activated carbon, the activated carbon bed further including an acid gas inlet in a lower portion of the drum, a main outlet in an upper portion of the drum, a steam inlet in an upper portion of the drum, and a steam outlet in a lower portion of the drum;
a main outlet line in fluid communication with the main outlet of the activated carbon bed, the main outlet line having a first diameter;
a main outlet valve in the main outlet line, the main outlet valve configured to prevent the flow of an acid gas through the main outlet line when closed;
a bypass line configured to allow a sweeping gas to bypass at least a portion of the main outlet line, the bypass line having a second diameter that is less than the first diameter of the main outlet line; and
a bypass line valve in the bypass line, the bypass line valve configure to stop the flow of an acid gas through the bypass line when closed.

11. The system of claim 10, wherein when the activated carbon bed is operated in an adsorption mode, main outlet valve is open and the bypass line valve is closed thereby resulting in an acid gas flowing to the reaction furnace at an operational flow rate, and when the activated carbon bed is conducting a sweeping process, the main outlet valve is closed and the bypass valve is open thereby resulting in a sweeping gas flowing to the reaction furnace at a sweeping flow rate, wherein the sweeping flow rate is less than the operational flow rate.

12. The system of claim 10, wherein the first diameter is about 30 inches and the second diameter is about 8 inches.

13. The system of claim 10, wherein the second diameter is in a range between 1/3^{rd} the first diameter and 1/4^{th} the first diameter.

14. The system of claim 10 further comprising a temperature indicator configured to obtain the temperature of the activated carbon bed and a control system receiving temperature data from the temperature indicator, wherein the control system opens the bypass valve when the activated carbon bed reaches a threshold temperature while the activated carbon bed thereby starting a sweeping process.

15. The system of claim 14, wherein the threshold temperature is about 250° F. or less.
